(19) United States
(12) Patent Application Publication
(10) Pub. No.: US 2011/0199257 A1
(43) Pub. Date: Aug. 18, 2011

(54) METHOD AND SYSTEM FOR UPDATING ALTITUDE INFORMATION FOR A LOCATION BY USING TERRAIN MODEL INFORMATION TO PRIME ALTITUDE SENSORS

(76) Inventors: David Lundgren, Mill Valley, CA (US); Charles Abraham, Los Gatos, CA (US); Mark Buer, Gilbert, AZ (US); David Garrett, Tustin, CA (US); Jeyhan Karaoguz, Irvine, CA (US); Dave Murray, Mission Viejo, CA (US)

(21) Appl. No.: 12/732,847

(22) Filed: Mar. 26, 2010

Related U.S. Application Data
(60) Provisional application No. 61/305,758, filed on Feb. 18, 2010.

(51) Int. Cl. G01S 19/42; G01S 3/02

(52) U.S. Cl. 342/357.25; 342/462; 342/451

(57) ABSTRACT

Methods and systems for updating altitude information for a location by using terrain model information to prime altitude sensors are disclosed and may include determining an altitude of a wireless device including one or more altimeters. The determination of altitude may include determining a location of the wireless device, receiving an altitude value for the location from an altitude database, and measuring a change in the altitude using the altimeters. The database may include a worldwide terrain database that may be stored on a remote device, such as a server. Part of the database may be stored on the wireless device and may be updated as the wireless device moves. The location may be determined utilizing a global navigation satellite system, which may include GPS, GLONASS, and GALILLEO. The location may be measured utilizing cellular service triangulation or by utilizing one or more access points with known locations.

### CROSS-REFERENCE TO RELATED APPLICATIONS/INCORPORATION BY REFERENCE

This application makes reference to, claims the benefit from, and claims priority to U.S. Provisional Application Ser. No. 61/305,758 filed on Feb. 18, 2010.

This application also makes reference to:

U.S. patent application Ser. No. ______ (Attorney Docket No. 20999U502) filed on even date herewith;
U.S. patent application Ser. No. ______ (Attorney Docket No. 21000U502) filed on even date herewith;
U.S. patent application Ser. No. 12/729,184 filed on Mar. 22, 2010;
U.S. patent application Ser. No. ______ (Attorney Docket No. 21004U502) filed on even date herewith;
U.S. patent application Ser. No. 12/729,197 filed on Mar. 22, 2010;
U.S. patent application Ser. No. ______ (Attorney Docket No. 21006U502) filed on even date herewith;
U.S. patent application Ser. No. ______ (Attorney Docket No. 21011U502) filed on even date herewith;
U.S. patent application Ser. No. ______ (Attorney Docket No. 21016U502) filed on even date herewith;
U.S. patent application Ser. No. ______ (Attorney Docket No. 21023U502) filed on even date herewith;
U.S. patent application Ser. No. ______ (Attorney Docket No. 21025U502) filed on even date herewith;
U.S. patent application Ser. No. 12/729,957 filed on Mar. 22, 2010;
U.S. Provisional Application Ser. No. 61/304,085 filed on Feb. 12, 2010;
U.S. Provisional Application Ser. No. 61/304,100 filed on Feb. 12, 2010;
U.S. Provisional Application Ser. No. 61/304,114 filed on Feb. 12, 2010;
U.S. Provisional Application Ser. No. 61/311,879 filed on Mar. 9, 2010;
U.S. Provisional Application Ser. No. 61/304,193 filed on Feb. 12, 2010;
U.S. Provisional Application Ser. No. 61/304,205 filed on Feb. 12, 2010;
U.S. Provisional Application Ser. No. 61/304,198 filed on Feb. 12, 2010;
U.S. Provisional Application Ser. No. 61/305,174 filed on Feb. 17, 2010;
U.S. Provisional Application Ser. No. 61/304,253 filed on Feb. 12, 2010;
U.S. Provisional Application Ser. No. 61/306,639 filed on Feb. 22, 2010; and
U.S. Provisional Application Ser. No. 61/309,071 filed on Mar. 1, 2010.

Each of the above stated applications is hereby incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to wireless communication. More specifically, certain embodiments of the invention relate to a method and system for updating altitude information for a location by using terrain model information to prime altitude sensors.

### BACKGROUND OF THE INVENTION

Global navigation satellite systems (GNSS) receivers may normally determine their position by receiving satellite broadcast signals from a plurality of satellites. These satellites, for example 24 at any time for the Global Positioning System (GPS), may broadcast radio frequency signals that comprise information that may be exploited by the satellite receiver to determine its own position. By measuring the time the broadcast signals may travel from the satellites to the satellite receiver, and the known position of the transmitting satellite, the satellite receiver may be able to determine its own position by trilateration. In general, at least 3 satellite signals may need to be decoded at the satellite receiver in order to determine its position.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for updating altitude information for a location by using terrain model information to prime altitude sensors, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating an exemplary wireless device with altitude determining capability, in accordance with an embodiment of the invention.

FIG. 1B is a diagram illustrating an exemplary satellite navigation system in a two-dimensional setting, in accordance with an embodiment of the invention.

FIG. 2 is a diagram of an altitude-tracking wireless device, in accordance with an embodiment of the invention.

FIG. 3 is a block diagram illustrating exemplary steps for updating altitude information for a location by using terrain model information to prime altitude sensors, in accordance with an embodiment of the invention.

### DETAILED DESCRIPTION OF THE INVENTION

Certain aspects of the invention may be found in a method and system for updating altitude information for a location by using terrain model information to prime altitude sensors. Exemplary aspects of the invention may comprise determining an altitude of a wireless device comprising one or more altimeters. The determination of the altitude may comprise determining a location of the wireless device and receiving an altitude value for the location from an altitude database. A change in the altitude of the wireless device may be measured using the one or more altimeters. The altitude database may comprise a worldwide terrain database that may be stored on a remote device, which may comprise a server. At least a portion of the altitude database may be stored on the wireless device and may be updated as the wireless device moves from the determined location. The location of the wireless device may be measured utilizing a global navigation satellite system, which may comprise a global positioning satellite (GPS), GLONASS, and/or Galileo system. The location of the wireless device may be determined utilizing cellular service triangulation or by utilizing one or more access points with known locations.

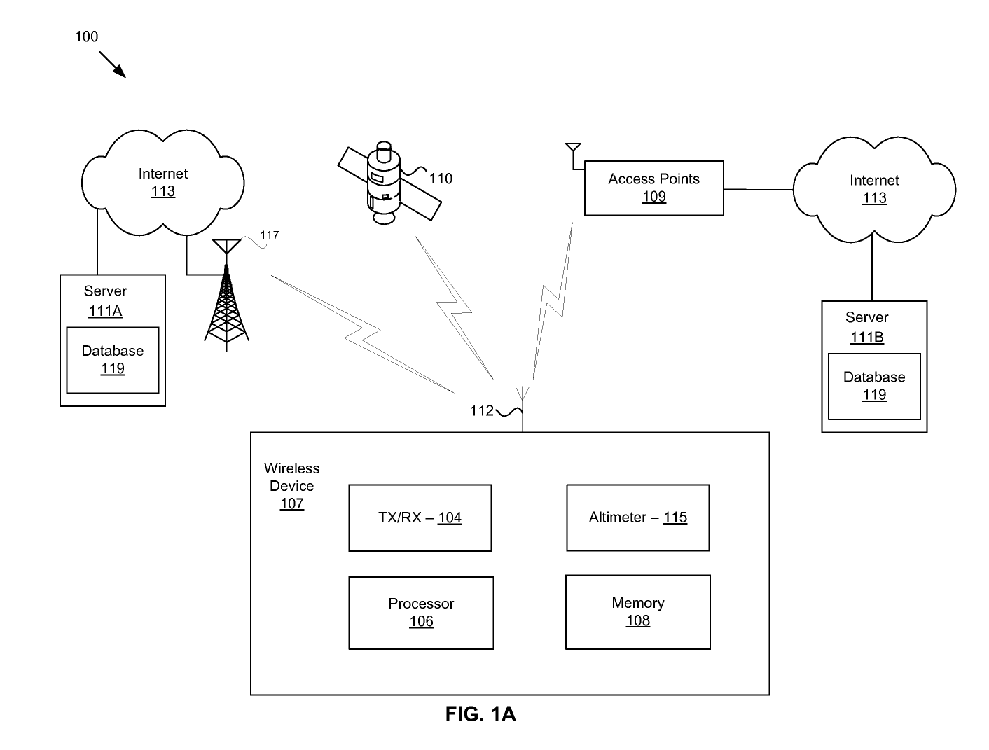

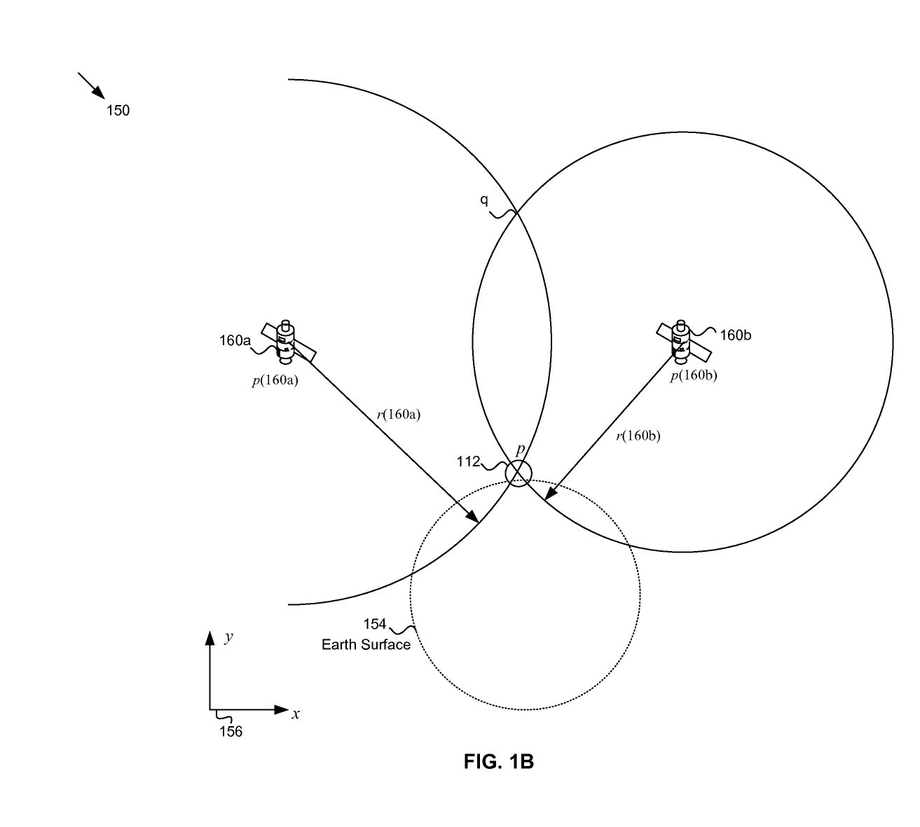

FIG. 1A is a diagram illustrating an exemplary wireless device with altitude determining capability, in accordance with an embodiment of the invention. Referring to FIG. 1A, there is shown an altitude monitoring system 100 comprising a wireless device 107, access points 109, servers 111A and 111B, the Internet 113, cellular towers 117, and satellites 110. The wireless device 107 may comprise a transmit/receive (TX/RX) module 104, a processor 106, a memory 108, and altimeter module 115.

The TX/RX module 104 may be communicatively coupled to one or more receiver antennas illustrated by the antenna 112. The wireless device 107 may comprise Global Navigation Satellite System (GNSS), cellular, WiFi, Zigbee, WiMax, 60 GHz and other wireless technology, for example.

The satellites 110 may comprise suitable logic, circuitry, interfaces, and/or code that may be operable to generate and broadcast suitable radio-frequency signals that may be received by a satellite receiver, for example the TX/RX 104, to determine the wireless device 107 position. The wireless device 107 may comprise any wireless device that may utilize GNSS technology, such as smart phones, PDAs, wireless access points, or cell phones, for example.

The TX/RX 104 may comprise suitable logic, circuitry, interfaces, and/or code that may be operable to receive signals broadcasted from a plurality of sources, such as the satellites 110, the cellular towers 117, and the access points 109. The received signals may be processed in order to determine the position or location of the wireless device 107. The TX/RX 104 may be operable to receive wireless signals via the receiver antenna 112 and process the received signals in order to generate baseband signals. Signal processing may be performed on the baseband signals by the processor 106.

The memory 108 may comprise suitable logic, circuitry, interfaces, and/or code that may enable storage and access to data and code suitable for the operations performed by the TX/RX 104 and the processor 106.

The server 111A and 111B may comprise one or more computer systems coupled to the Internet that may be operable to store and provide information to the wireless device 108. The servers 111A and 111B may comprise a worldwide terrain database 119 that may comprise altitude data for points across the surface of the Earth. For example, the worldwide terrain database 119 may comprise altitude data for 10⁹ latitude and longitude points. This data may be accessed by wireless devices via the Internet, for example.

The altimeter module 115 may comprise suitable logic, circuitry, interfaces, and/or code that may be operable to determine relative altitude changes. The altimeter module 115 may comprise a barometric pressure altimeter, for example, that may be operable to accurately track the altitude of a device when calibrated to a known altitude. For example, the altimeter 115 may be calibrated to a known altitude, such as by knowing the altitude of a particular location, and may be operable to accurately measure any changes from that altitude. In one embodiment of the invention, the altimeter module 115 may comprise a MEMS module.

In FIG. 1A, an exemplary location-determining scenario may be illustrated, wherein the TX/RX 104 may receive a plurality of signals from which the processor 106 may be able to extract information that may enable the wireless device 107 to determine its position. The TX/RX 104 and the satellites 110, may be operating in compliance with the Global Positioning System (GPS) developed and operated by the United States of America Department of Defense. In accordance with various embodiments of the invention, the invention may not be limited to application in GPS and may be applied to other GNSS systems, for example GALILEO, GLONASS, IRNSS, and BEIDOU.

In operation, the location of the wireless device 107 may be determined by one or more methods. For example, triangulation may be utilized to determine location from two or more cellular towers, or GNSS location-determining capability may be enabled when signals are received from two or more of the satellites 110. In another embodiment of the invention, the location of the wireless device 107 may be determined utilizing two or more cellular towers of the cellular towers 117. The location of the wireless device 107 may thus be determined by triangulating the received signals.

In an exemplary embodiment of the invention, the location of the wireless device 107 may be determined utilizing one or more access points 109 with a known position. For example, the access points 109 may have GNSS capability that periodically updates its known position. This information may be exchanged with wireless devices that utilize the access points 109.

Once the wireless device location has been determined, its altitude may be determined from the worldwide terrain database 119 via the Internet and a wireless communication channel such as the cellular towers 117 and/or the access points 109, for example. The wireless device 107 may then monitor its altitude utilizing the altimeter module 115, which may be operable to accurately track the change in altitude from the original altitude retrieved from the worldwide terrain database 119.

In another embodiment of the invention, all or a localized portion of the worldwide terrain database 119 may be stored on the wireless device in the memory 108, for example. The data from the worldwide terrain database 119 stored locally on the wireless device 107 may be periodically updated as the wireless device 107 moves. The localized portion of the database that may be stored on the wireless device 107 may be updated as the wireless device moves from location to location.

FIG. 1B is a diagram illustrating an exemplary satellite navigation system in a two-dimensional setting, in accordance with an embodiment of the invention. Referring to FIG. 1B, there is shown a satellite navigation system 150, comprising the wireless device 112 (illustrated by a small circle) at position p, satellites 160a and 160b, an earth surface 154 illustrated by a dotted circle, and an exemplary two-dimensional coordinate system 156. There is also shown a position of satellite 160a denoted p(160a), a position of satellite 160b denoted p(160b), an intersection point q, a range from satellite 160a to the satellite receiver 102 r(160a) and a range from satellite 160b to the satellite receiver 102 r(160b).

To illustrate the principles involved in determining a position of the wireless device 112 from the satellites, for example the satellites 160a and 160b, it may be useful to consider a two-dimensional scenario as illustrated in FIG. 1B. The three-dimensional case encountered in reality may be considered an extension to three dimensions of the principles demonstrated in the two-dimensional case. As illustrated in FIG. 1B, the principle of determining the position p of the satellite receiver 102 may be to measure the range from the wireless device 112 to a plurality of satellites, for example r(160a) and r(160b), based on the known positions of the satellites, for example p(160a), and p(160b). Based on the measured ranges from the satellites 160a and 160b to the wireless device 112 and the known position of the satellites, each satellite may define a circle of positions that lie at a given range from the satellite, as illustrated in FIG. 1B. In the case of two satellites, there may be two intersection points: one may be the desired position p and the other may be the intersection q. As may be observed from FIG. 1B, only p may be close to the surface of the earth. Hence, only p may be a feasible solution for the position of the wireless device 112. Therefore, in the depicted two-dimensional scenario of FIG. 1B, two satellites may suffice in principle to determine the position p. The position p may be given by one solution to the following relationships in the two-dimensional case:

r(k)=||p(k)−p||, k=160a, 160b EQ. 1

In three dimensions, the circles around the satellites may become spheres and the intersection of two spheres may generate a circle of feasible solutions. By intersecting the circle with a further sphere, two possible positions will be found. Again, only one of the two solutions will be close to the surface of the earth. Therefore, in the three dimensional case, the solution may require 1 more satellite to resolve the extra dimension and the position may be resolved from the following relationship, where each k may denote a different satellite:

r(k)=||p(k)−p||, k=1,2,3 EQ. 2

Each satellite, for example satellites 160a and 160b, may broadcast a signal that may comprise information to determine the satellite's position. Once placed in orbit, a satellite's position may be predictable. This predicted position of the satellites may generally be available in an almanac at the satellite receiver and may be stored, for example, in the memory 108. Due to certain imperfections in computing the satellite's position, a GPS ground station may monitor the satellite's exact position. In order to correct for any deviations from the almanac position, the ground station may supply the satellite with data that may allow the satellite's position to be determined to a high degree of accuracy when received by a satellite receiver. This data may be valid for a limited time only and may be referred to as ephemeris data. Its ephemeris data may be broadcast by each satellite, and may be received by the satellite receiver. The satellite position p(k,t) of satellite k, may be computed using the ephemeris data. The almanac position P(k,t)of a given satellite k may hence be related to the position p(k,t) together with a correction term Δ(k,t) from the following relationship:

p(k,t)=P(k,t)+Δ(k,t) EQ. 3

where the variable t may denote time and indicate that the position of the satellite may change as a function of time. In instances where the correction term Δ(k,t) may be available at a satellite receiver, for example the wireless device 112, the exact position of the satellite k may be determined to a high degree of accuracy.

The satellite navigation system 150 may be utilized to determine a starting location of the wireless device 102 comprising a latitude and longitude point. The altitude determined from GNSS may not be as accurate as a user desires, and may not precisely track changes in altitude of the wireless device 107. In addition, GNSS service may not be available at all times that altitude measurement may be desired. Accordingly, the latitude and longitude data may be utilized to determine a more accurate altitude value from the worldwide terrain database 119, described with respect to FIG. 1A. Once the altitude has been retrieved, the wireless device 107 may track altitude utilizing an altimeter, as described with respect to FIG. 1A.

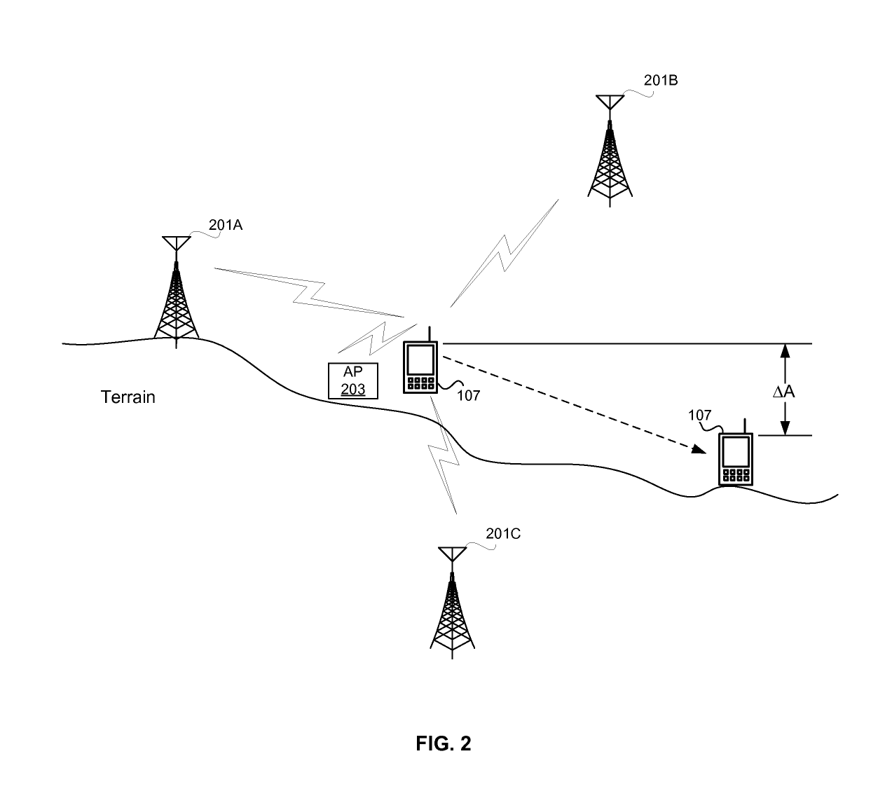

FIG. 2 is a diagram of an altitude-tracking wireless device, in accordance with an embodiment of the invention. Referring to FIG. 2 there is shown cellular towers 201A-201C, an access point 203, and the wireless device 107. The cellular towers 201A-201C and the access point 203 may be substantially similar to the cellular towers 117 and the access points 109 described with respect to FIGS. 1A and 1B.

In operation, the wireless device 107 may determine its location by one or more location techniques, such as GNSS positioning, cellular triangulation, or by its proximity to one or more communication devices such as the access point 107. The latitude and longitude data of the determined location may be used to retrieve an altitude value from a database, such as the worldwide terrain database, described with respect to FIG. 1A.

Once the latitude for a determined location is received, the wireless device may track the altitude of the device as it moves. For example, as the wireless devices moves down the slope as shown by the dashed line in FIG. 2, an altimeter, such as the altimeter module 115 in the wireless device 107, may accurately measure the change in altitude, AA. In this manner, the wireless device 107 may be operable to accurately determine its altitude without requiring an altimeter capable of absolute accuracy, as opposed to one capable of precision with respect to a known altitude, and without depending on GNSS which may not be available at all times, or have the desired accuracy.

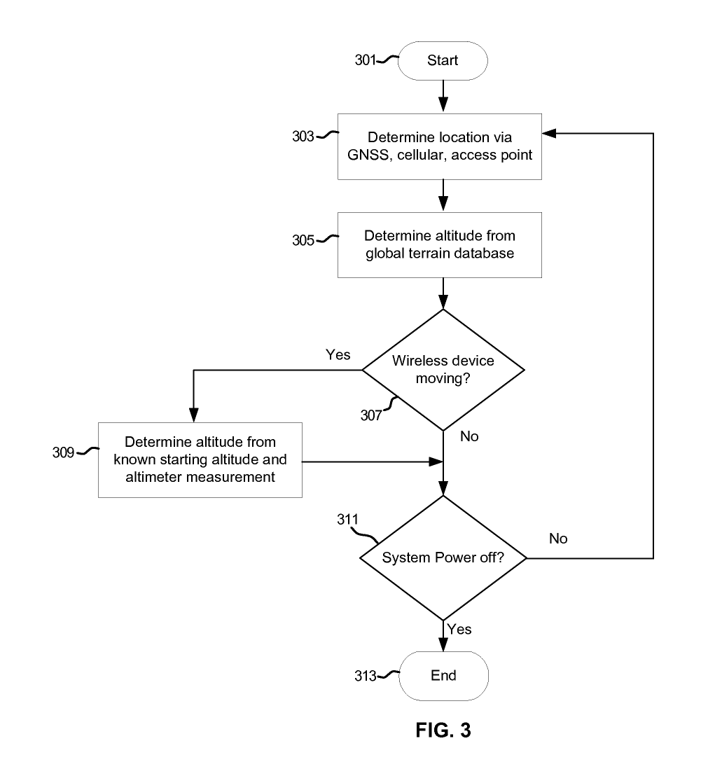

FIG. 3 is a block diagram illustrating exemplary steps for updating altitude information for a location by using terrain model information to prime altitude sensors, in accordance with an embodiment of the invention. Referring to FIG. 3, in step 303 after start step 301, the location of the wireless device 107 may be determined using GNSS, cellular triangulation, or proximity to a wireless point with a known location. In step 305, the determined location may be utilized to retrieve an altitude value from the worldwide terrain database 119. In step 307, in instances where the wireless device 107 may be moving, the exemplary steps may proceed to step 309 where the altitude may be tracked by the altimeter module 115 before proceeding to step 311. If, in step 307, the wireless device 107 may not be moving, the exemplary steps may proceed directly to step 311. In step 311, in instances where the wireless device 107 is to be powered down, the exemplary steps may proceed to end step 313. In step 311, in instances where the wireless device 107 is not to be powered down, the exemplary steps may proceed to step 303 to determine the location of the wireless device 107 using GNSS positioning, cellular triangulation, and/or proximity to one or more communication devices such as a base station, another wireless communication device, or a wireless access point with a known location.

In an embodiment of the invention, a method and system are disclosed for determining an altitude of a wireless device 107 comprising one or more altimeters 115. The determination of altitude may comprise determining a location of the wireless device 107 and receiving an altitude value for the location from an altitude database 119. A change in the altitude of the wireless device 107 may be measured using the one or more altimeters 115. The altitude database 119 may comprise a worldwide terrain database that may be stored on a remote device, which may comprise a server 111A and 111B. At least a portion of the altitude database 119 may be stored on the wireless device 107 and may be updated as the wireless device 107 moves from the determined location. The location of the wireless device 107 may be determined utilizing a global navigation satellite system, such as, for example, a global positioning satellite (GPS) system, GLONASS, and/or GALILLEO. The location of the wireless device 107 may be determined utilizing cellular service triangulation or by utilizing one or more access points with known locations 109.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for updating altitude information for a location by using terrain model information to prime altitude sensors.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for communication, the method comprising:
in a wireless device comprising one or more altimeters:
determining an altitude of said wireless device, wherein said determining comprises:
determining a location of said wireless device;
receiving an altitude value for said determined location; and
measuring a change in said altitude of said wireless device using said one or more altimeters.

2. The method according to claim 1, comprising receiving said altitude value from an altitude database that comprises a worldwide terrain database.

3. The method according to claim 2, wherein said altitude database is stored on a remote device.

4. The method according to claim 3, wherein said remote device comprises a server.

5. The method according to claim 2, comprising storing at least a portion of said altitude database on said wireless device.

6. The method according to claim 5, comprising updating said at least a portion of said altitude database stored on said wireless device as said wireless device moves from said measured location.

7. The method according to claim 1, comprising determining said location of said wireless device utilizing a global navigation satellite system.

8. The method according to claim 1, wherein said global navigation satellite system comprises global positioning satellite (GPS) system, GLONASS, and GALILEO.

9. The method according to claim 1, comprising determining said location of said wireless device utilizing cellular service triangulation

10. The method according to claim 1, comprising determining said location of said wireless device utilizing one or more access points with known locations.

11. A system for enabling communication, the system comprising:
a wireless device comprising one or more altimeters, said wireless device being operable to:
determine an altitude of said wireless device, by being operable to, at least:
determine a location of said wireless device;
receive an altitude value for said determined location; and
measure a change in said altitude of said wireless device using said one or more altimeters.

12. The system according to claim 11, wherein said wireless device is operable to receive said altitude value from an altitude database that comprises a worldwide terrain database.

13. The system according to claim 12, wherein said altitude database is stored on a remote device.

14. The system according to claim 13, wherein said remote device comprises a server.

15. The system according to claim 12, wherein said wireless device is operable to store at least a portion of said altitude database on said wireless device.

16. The system according to claim 15, wherein said wireless device is operable to update said at least a portion of said altitude database stored on said wireless device as said wireless device moves from said measured location.

17. The system according to claim 11, wherein said wireless device is operable to determine said location of said wireless device utilizing a global navigation satellite system.

18. The system according to claim 11, wherein said global navigation satellite system comprises global positioning satellite (GPS) system, GLONASS, and GALILEO.

19. The system according to claim 11, wherein said wireless device is operable to determine said location of said wireless device utilizing cellular service triangulation.

20. The system according to claim 11, wherein said wireless device is operable to determine said location of said wireless device utilizing one or more access points with known locations.
